(19) United States
(12) Patent Application Publication
(10) Pub. No.: US 2025/0159095 A1
(43) Pub. Date: May 15, 2025

(54) IMAGE FORMATION APPARATUS, IMAGE FORMATION METHOD, AND STORAGE MEDIUM

(71) Applicant: CANON KABUSHIKI KAISHA, Tokyo (JP)

(72) Inventor: SATOKI WATARIUCHI, Tokyo (JP)

(21) Appl. No.: 18/945,078

(22) Filed: Nov. 12, 2024

(30) Foreign Application Priority Data
Nov. 14, 2023 (JP) 2023-193560

(51) Int. Cl. H04N 1/387; H04N 1/00

(52) U.S. Cl. CPC H04N 1/387; H04N 1/00702; H04N 1/00708; H04N 1/00737; H04N 1/00771

(57) ABSTRACT

The usability in a case where a combined image, which is obtained by integrating two scanned images of a specific original, is generated is improved. An image formation apparatus includes: a setting unit configured to set a layout method applied in a case where a combined image, which is obtained by integrating two scanned images corresponding to two original surfaces obtained by scanning a specific original, is generated; a detection unit configured to detect a position of the specific original placed on a platen glass for the scanning; and a notification unit configured to notify of a warning message in a case where the position of the specific original detected by the detection unit is different from a position of the specific original according to the layout method set by the setting unit.

### BACKGROUND OF THE INVENTION

### Field of the Invention

The present disclosure relates to an image formation apparatus, an image formation method, and storage medium.

### Description of the Related Art

An image formation apparatus has an ID card copying function to generate a combined image, which is obtained by integrating scanned images of two original surfaces obtained by scanning a front surface and a back surface of a specific original such as an ID card including a license, for example. Regarding this ID card copying function, Japanese Patent Laid-Open No. 2009-100102 (PTL 1) discloses a technique in which predetermined image processing according to a type and an original surface of a designated specific original is performed on a scanned image of the original surface obtained by scanning the original surface of the specific original.

However, with the technique disclosed in PTL 1, in a case where the above-described ID card copying function is performed, if a position of the specific original placed on a platen glass for the scanning is different from a position set in advance, there is a possibility that a desired output result cannot be obtained.

For example, it is assumed in the above-described ID card copying function that a region corresponding to a license size, in which the origin is at the upper left of the platen glass, is set as a reading region of the specific original. In a case of such setting, if the position of the license placed on the platen glass is outside the above-described reading region, it has been only possible to form an image in which a scanned image including no image of the license is laid out on one surface of a single sheet.

Additionally, in a case where the license placed on the platen glass is in a position traversing the inside and the outside of the above-described reading region, it has been only possible to form an image in which a scanned image including an image of a part of the entire one surface of the above-described license that is within the above-described reading region is laid out. Moreover, since it has been impossible to determine the quality of an output result without looking the output result, it has been necessary to redo the operations from the reading of the license in a case where the license cannot be read appropriately, and the user operation has been cumbersome.

### SUMMARY OF THE INVENTION

An image formation apparatus according to an aspect of the present disclosure includes: a setting unit configured to set a layout method applied in a case where a combined image, which is obtained by integrating two scanned images corresponding to two original surfaces obtained by scanning a specific original, is generated; a detection unit configured to detect a position of the specific original placed on a platen glass for the scanning; and a notification unit configured to notify of a warning message in a case where the position of the specific original detected by the detection unit is different from a position of the specific original according to the layout method set by the setting unit.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration example of an image formation apparatus;

FIG. 2 is a block diagram illustrating a software configuration example of the image formation apparatus;

FIG. 3 is a diagram showing the relationship of FIG. 3A and FIG. 3B;

FIG. 3A and FIG. 3B are flowcharts describing processing of an ID card copying function;

FIGS. 4A to 4G are diagrams illustrating a UI screen example;

FIG. 5 is a flowchart illustrating a flow of processing of setting a check range;

FIG. 6 is a diagram showing the relationship of FIG. 6A and FIG. 6B;

FIG. 6A and FIG. 6B are flowcharts describing processing of the ID card copying function;

FIG. 7 is a diagram showing the relationship of FIG. 7A and FIG. 7B;

FIG. 7A and FIG. 7B are flowcharts describing processing of the ID card copying function; and

FIGS. 8A to 8D are diagrams illustrating a UI screen example.

### DESCRIPTION OF THE EMBODIMENTS

Embodiments of a technique of the present disclosure are described below with reference to the drawings. Note that, a constituent described in the following embodiments is an example and is not intended to limit the scope of the technique of the present disclosure. Note that, each step in a flowchart is described with “S” provided at the beginning.

### Embodiment 1

In the present embodiment, an aspect in which one surface of an ID card is scanned two times in total, which is pre-scanning to detect a position of the card placed on a platen glass and scanning to obtain printing data, is described.

### (Hardware Configuration of Image Formation Apparatus)

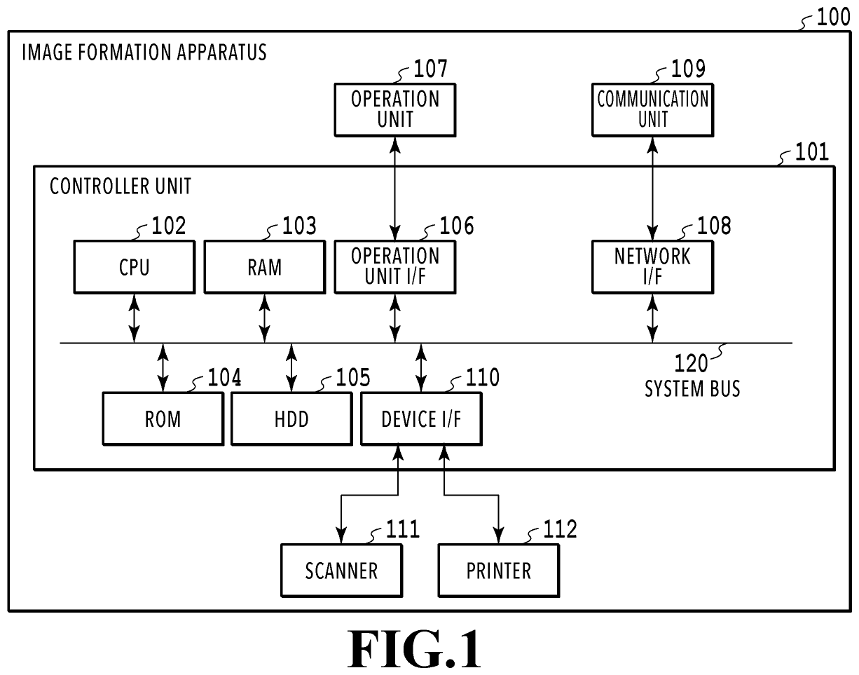

FIG. 1 is a block diagram illustrating a hardware configuration example of an image formation apparatus 100 according to the present embodiment. The image formation apparatus 100 includes a controller unit 101, an operation unit 107, a communication unit 109, a scanner 111, and a printer 112. The controller unit 101 controls the scanner 111, the printer 112, the operation unit 107, and the communication unit 109. In a case where a user uses a copying function, the controller unit 101 obtains, as image data of an original, a scanned image corresponding to an original surface that is obtained by reading the original placed on a platen glass by controlling the scanner 111. The controller unit 101 then controls the printer 112 and prints and outputs an image on a sheet based on the obtained image data.

Additionally, in a case where the user uses a scanning function, the controller unit 101 obtains the image data of the original by controlling the scanner 111, converts the image data into code data, and transmits the code data to an external device (not illustrated) via the communication unit 109. An instruction to execute processing in each of the above-mentioned functions is called a job, and the image formation apparatus 100 executes predetermined processing according to the job corresponding to each function.

The controller unit 101 includes a CPU 102, a RAM 103, a ROM 104, an HDD 105, an operation unit I/F 106, a network I/F 108, and a device I/F 110. These devices are connected with a system bus 120 so as to be able to transmit and receive data to and from each other.

The central processing unit (CPU) 102 controls overall the entirety of the image formation apparatus 100. The random access memory (RAM) 103 is a system working memory for an operation by the CPU 102 and is an image memory to temporarily store the image data. Additionally, the RAM 103 also stores a program and data such as an operating system, system software, and application software. Moreover, the RAM 103 stores data of the scanned image corresponding to the original surface obtained with the scanner 111 reading the original placed on the platen glass and stores the printing data received from the controller unit 101 via a network. The read only memory (ROM) 104 stores a boot program of a system. The HDD (hard disk drive) 105 stores the operating system, the system software, the application software, the printing data, setting data, and the like.

The operation unit I/F 106 is an interface unit for the operation unit 107 and outputs information to be displayed on the operation unit 107 to the operation unit 107. Additionally, the operation unit I/F 106 receives information inputted by the user from the operation unit 107.

The network I/F 108 is connected with the communication unit 109 and controls various communications established with the external device. The device I/F 110 connects the scanner 111 that executes reading of the original to the controller unit 101 and also connects the printer 112 that executes printing based on the image data to the controller unit 101 to input and output the image data.

The scanner 111 includes the platen glass to execute pre-scanning to detect a sheet size and a position of the original placed on the platen glass and execute scanning for the printing data obtainment in which the original placed on the platen glass is read to generate the image data.

### (Software Configuration of Image Formation Apparatus)

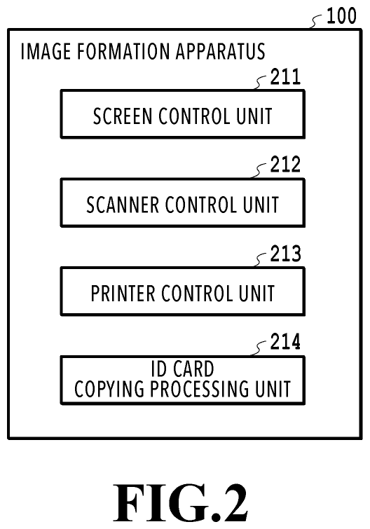

FIG. 2 is a block diagram illustrating a software configuration example of the image formation apparatus 100 according to the present embodiment. Each block in FIG. 2 is software stored in the ROM 104 or the HDD 105 and implements processing described later with the CPU 102 reading out the software to the RAM 103 to execute. The image formation apparatus 100 includes a screen control unit 211, a scanner control unit 212, a printer control unit 213, and an ID card copying processing unit 214.

The screen control unit 211 controls the operation unit 107 via the operation unit I/F 106. The screen control unit 211 receives the information inputted to the operation unit 107 by the user operation and generates a screen to be displayed on the operation unit 107.

The scanner control unit 212 controls the scanner 111 via the device I/F 110 and generates the image data by reading the original placed on the platen glass.

The printer control unit 213 controls the printer 112 via the device I/F 110 and prints and outputs the image based on the image data on the sheet.

The ID card copying processing unit 214 performs processing to implement an ID card copying function. The ID card copying processing unit 214 generates the printing data integrating front surface image data and back surface image data of the ID card on one surface of a single sheet based on setting of the ID card copying and checks the position of the ID card placed on the platen glass. That is, the ID card copying processing unit 214 generates a combined image, which is obtained by integrating two scanned images corresponding to two original surfaces obtained by scanning the front surface and the back surface of the ID card (a specific original) according to a set layout method, which is described later in detail. Additionally, the ID card copying processing unit 214 detects the position of the ID card (the specific original) by checking a range determined in advance on the platen glass.

### (Processing of Executing ID Card Copying Function)

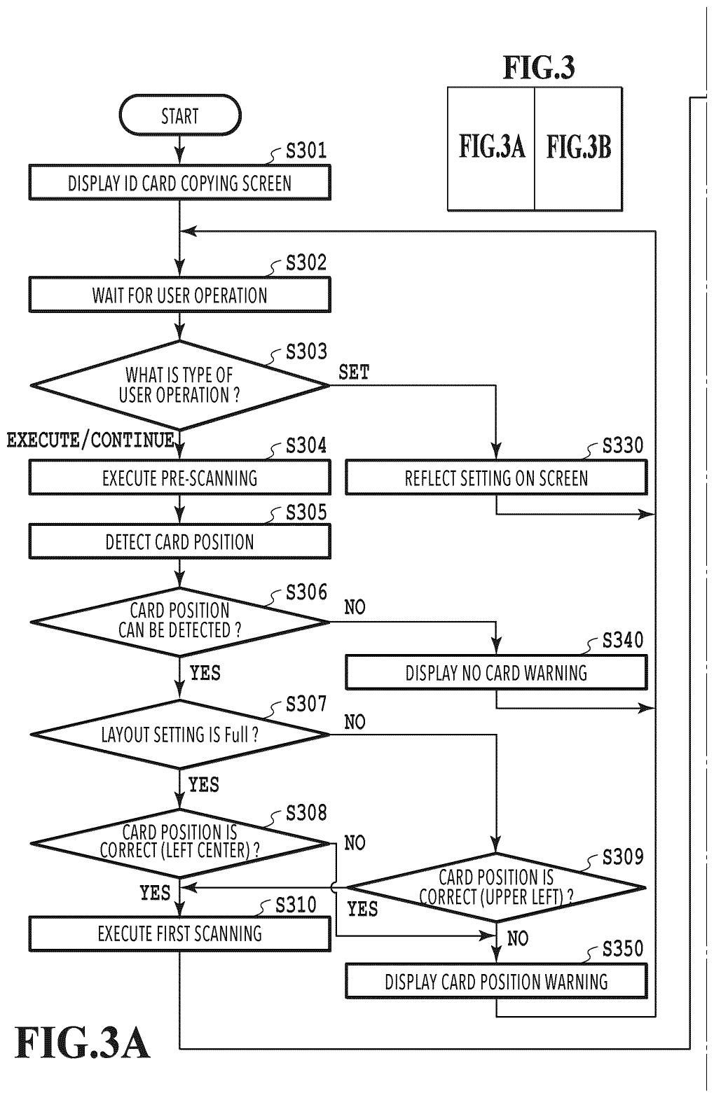

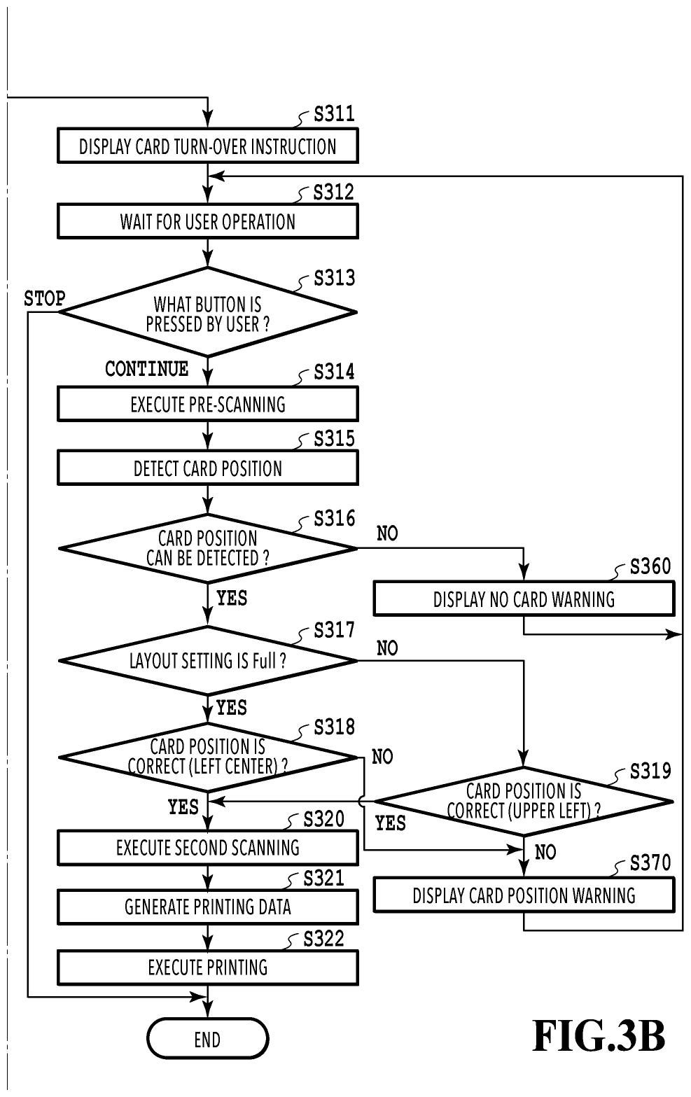

FIG. 3A and FIG. 3B are flowcharts describing processing of the ID card copying function executed by the image formation apparatus 100 according to the present embodiment. The flowcharts in FIG. 3A and FIG. 3B are implemented with the CPU 102 of the image formation apparatus reading out the program to implement each software module stored in the ROM 104 or the HDD 105 to the RAM 103 to execute.

In the present embodiment, the ID card copying function is configured as an independent application; however, it is not limited thereto. The ID card copying function may be prepared as one function of a copying application. Note that, the ID card is placed in a predetermined position on the platen glass with the back surface of the ID card facing up.

In S301, in a case where the screen control unit 211 receives an instruction to execute the ID card copying function by the user operation on the operation unit 107, the screen control unit 211 activates an ID card copying application and displays an ID card copying screen on the operation unit 107.

### (ID Card Copying Screen)

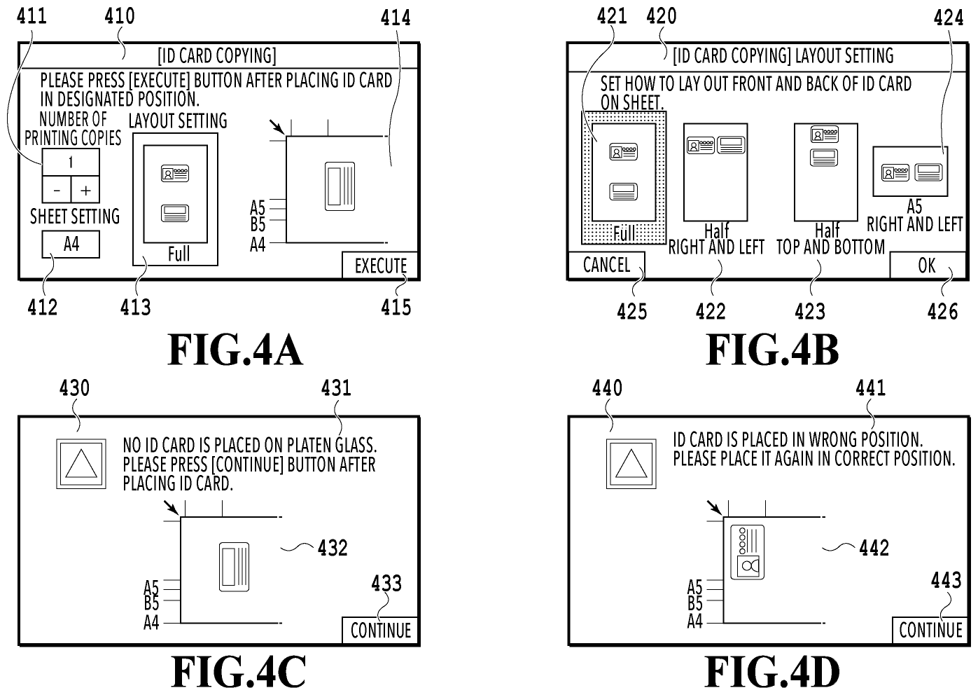

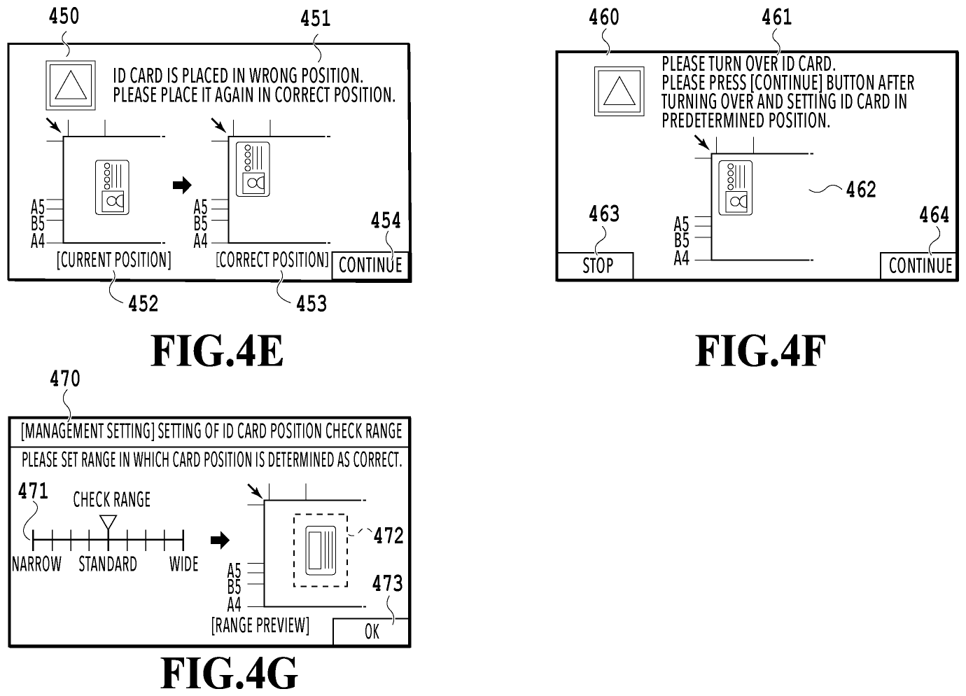

FIG. 4A is a diagram illustrating an ID card copying screen example. An ID card copying screen 410 includes copy number setting 411, sheet size setting 412, layout setting 413, a guide display region 414, and an “execute” button 415. The copy number setting 411 is a part to display setting of the number of printing copies and set the number of printing copies. The user changes the setting of the number of printing copies by using a “+” button to perform an operation to increment the number of printing copies and a “−” button to perform an operation to decrement the number of printing copies. The sheet size setting 412 is a part to display setting of the printing sheet size and set the printing sheet size. The sheet size setting 412 is a button and displays a screen (not illustrated) to select the printing sheet size by pressing.

The layout setting 413 is a part to display setting of the layout method to how to lay out the image of the front surface and the image of the back surface of the ID card on the printing sheet and set the layout method. The layout setting 413 is a button and displays a screen (for example, a screen illustrated in FIG. 4B) to select the setting of the layout method by being pressed. The guide display region 414 is a region to display a guide image describing which position the ID card should be placed on the platen glass. The guide image indicates a correct position of the ID card placed on the platen glass. The guide display region 414 updates the position of the ID card according to each setting to an appropriate position (the position of the ID card corresponding to each setting). A relationship between each setting and the position of the ID card on the platen glass is described later with reference to FIG. 4B. The “execute” button 415 is a button to instruct starting the execution of the ID card copying function.

### (Layout Setting Screen)

FIG. 4B is a diagram illustrating a layout setting screen example. A layout setting screen 420 is displayed on the operation unit 107 by pressing the layout setting 413 on the ID card copying screen 410 illustrated in FIG. 4A by the user operation. In the present embodiment, there are four types of layout methods, which are “Full”, “Half right and left”, “Half top and bottom”, and “A5 right and left”, as the layout method that allows for the layout setting. Additionally, the position in which the ID card should be placed on the platen glass is different depending on the setting of the layout method. That is, the appropriate position of the ID card placed on the platen glass is different according to the set layout method.

In a case where the layout method “Full” is set as the layout method, the ID card needs to be placed in a position that is the center (hereinafter, left center) in a horizontal direction and a vertical direction in a region of the left half of the platen glass. Additionally, in a case where the layout method other than “Full” (“Half right and left”, “Half top and bottom”, and “A5 right and left”) is set as the layout method, the ID card needs to be placed in a position that is a position away from the upper left of the platen glass by a few millimeters (hereinafter, upper left). The layout method and the position in which the ID card is placed that corresponds to the layout method is an example, and it is not limited thereto. Additionally, the position in which the ID card is placed is determined uniquely by a processing method in a case where the front surface and the back surface of the ID card are scanned thereafter and are laid out on the one surface (an image) of the single sheet; however, it is not limited to the dependence only on the set layout method. For example, the position in which the ID card is placed may be different depending on the sheet setting.

The layout setting screen 420 includes buttons 421 to 424 corresponding to the settable layout methods, respectively, a “cancel” button 425, and an “OK” button 426. The buttons 421 to 424 are buttons to change the layout method to be set, and the button pressed by the user operation is in a selected state.

The button 421 is a button to set the layout method of “Full”. That is, the button 421 is a button to select setting in which the printing direction is the vertical direction, and the two scanned images corresponding to the front surface and the back surface of the ID card, respectively, are laid out next to each other in the vertical direction in an entire region on the one surface of the sheet.

The button 422 is a button to set the layout method of “Half right and left”. That is, the button 422 is a button to select setting in which the printing direction is the vertical direction, and the two scanned images corresponding to the front surface and the back surface of the ID card, respectively, are laid out next to each other in the horizontal direction in an upper half region on the one surface of the sheet.

The button 423 is a button to set the layout method of “Half top and bottom”. That is, the button 423 is a button to select setting in which the printing direction is the vertical direction, and the two scanned images corresponding to the front surface and the back surface of the ID card, respectively, are laid out next to each other in the vertical direction in the upper half region on the one surface of the sheet.

The button 424 is a button to set the layout method of “A5 right and left”. That is, the button 424 is a button to select setting in which the printing direction is the horizontal direction, and the two scanned images corresponding to the front surface and the back surface of the ID card, respectively, are laid out next to each other in the horizontal direction in the entire region on the one surface of the sheet of an A5 size.

The “cancel” button 425 is a button to return to the previous screen without changing the setting of the layout method. The “OK” button 426 is a button to return to the previous screen by determining the setting of the layout method currently selected from the buttons 421 to 424.

Back to the description of the flowchart in FIG. 3A. In S302, the ID card copying processing unit 214 waits for the operation by the user via the screen control unit 211. That is, the ID card copying processing unit 214 waits for an input by the user operation on the ID card copying screen. In S303, the ID card copying processing unit 214 determines a type of the detected user operation. The processing diverges depending on the determination result. That is, if the type of the detected user operation is “set”, the processing proceeds to S330, and if the type of the detected user operation is “execute” or “continue”, the processing proceeds to S304.

The type of the user operation of “set” is an operation to perform setting for the ID card copying function such as, for example, increase and decrease of the number of copies in a region of the copy number setting 411 and the setting of the layout method on the layout setting screen 420. In S330, the ID card copying processing unit 214 reflects a setting value set by the user operation on the ID card copying screen 410. Then, once the reflecting of the setting value on the ID card copying screen 410 ends, the processing returns to S302.

The type of the user operation of “execute” or “continue” is an operation corresponding to pressing of the “execute” button 415 or pressing of a “continue” button 433 in FIG. 4C, a “continue” button 443 in FIG. 4D, and a “continue” button 454 in FIG. 4E described later. In S304, the ID card copying processing unit 214 executes the pre-scanning by controlling the scanner 111 via the scanner control unit 212. The pre-scanning is scanning different from the scanning to generate the image data for printing (the scanning for printing data obtainment) and is scanning to check the position and the like of the original placed on the platen glass. In the pre-scanning, in order to shorten the scanning time than a case of the scanning in S310 and S320 described later, the scanning is performed at a lower resolution than that in a case of the scanning in S310 and S320 and the scanning is performed halfway on the platen glass.

In S305, the ID card copying processing unit 214 detects the card position from the image data obtained by the pre-scanning in S304. Specifically, the ID card copying processing unit 214 performs image recognition of the image data obtained by scanning the entire platen glass at the lowest resolution and identifies the position of the ID card in the image data to identify the position of the ID card placed on the platen glass.

In S306, the ID card copying processing unit 214 determines whether the card position can be detected in S305. The processing diverges depending on the determination result. If the determination result indicating that the card position can be detected is obtained (YES in S306), the processing proceeds to S307. If the determination result indicating that the card position cannot be detected is obtained (NO in S306), the processing proceeds to S340. In S340, the ID card copying processing unit 214 displays a no card warning screen indicating that no ID card is placed on the platen glass on the operation unit 107 via the screen control unit 211. Note that, once the processing in S340 ends, the processing returns to S302.

### (No Card Warning Screen)

FIG. 4C is a diagram illustrating a no card warning screen example. A no card warning screen 430 includes a warning message 431, a guide display region 432, and the “continue” button 433. The no card warning screen 430 is also used in S360 (warning for second scanning) described later. The warning message 431 is a message indicating that no ID card is placed on the platen glass and indicating an operation procedure to continue the processing. The guide display region 432 is a region to display the guide image describing the position in which the ID card should be placed on the platen glass. As with the guide display region 414 illustrated in FIG. 4A, the guide display region 432 is a region to display an image expressing the ID card in the appropriate position depending on each setting. Additionally, a design of the ID card displayed in the guide display region 432 is also switched depending on whether it is a warning for the first scanning or a warning for the second scanning. For example, in the first scanning, a design on the back surface side of the card is displayed because the front surface of the ID card is scanned. In the second scanning, a design on the front surface side of the card is displayed because the back surface of the ID card is scanned.

The guide display region 432 in FIG. 4C illustrates an example in a case where the layout method of Full (the correct card position is the left center) is set, and it is a warning corresponding to the first scanning (the design of the card is the back surface). The “continue” button 433 is a button to instruct the processing to continue.

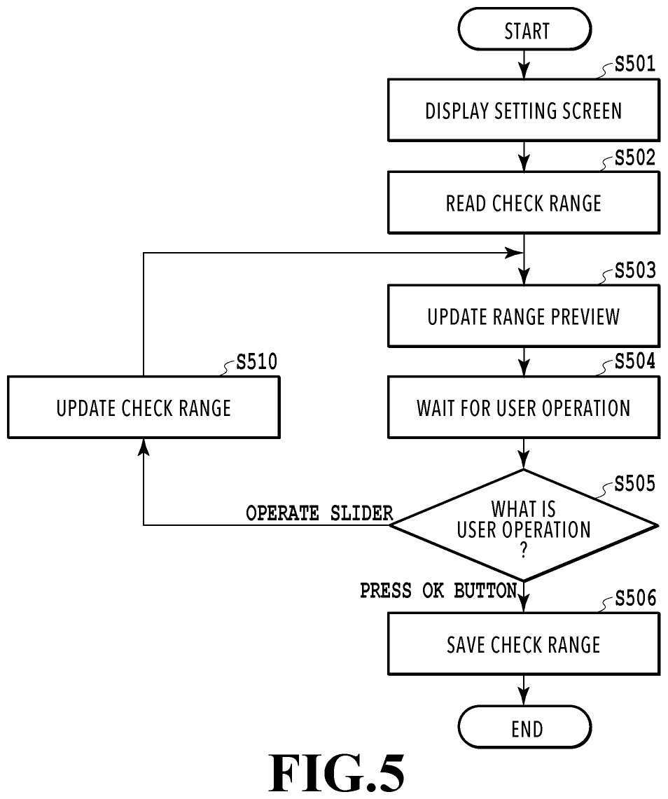

Back to the description of the flowchart in FIG. 3A. In S307, the ID card copying processing unit 214 determines whether the layout method of Full is set as the layout setting. If the determination result indicating that the layout method of Full is set is obtained (YES in S307), the processing proceeds to S308. If the determination result indicating that the layout method of Full is not set is obtained (NO in S307), the processing proceeds to S309. In S308, the ID card copying processing unit 214 determines whether the detected card position is placed in the correct position. That is, whether the detected card position is placed in the left center, which is the position of the center in the left half region of the platen glass, is determined. Specifically, it is determined based on whether the card position detected by the pre-scanning is within a check range. The check range is a range to determine that the card position is in the correct position and is set with reference to FIG. 5 described later, for example. If the determination result indicating that the detected card position is the correct position (the left center) is obtained (YES in S308), the processing proceeds to S310. If the determination result indicating that the detected card position is not the correct position (the left center) is obtained (NO in S308), the processing proceeds to S350. On the other hand, in S309, the ID card copying processing unit 214 determines whether the detected card position is placed in the correct position. That is, whether the detected card position is placed at the upper left, which is the position at the upper left on the platen glass, is determined. Note that, the check range used in S309 is also set with reference to FIG. 5 described later, for example. If the determination result indicating that the detected card position is the correct position (the upper left) is obtained (YES in S309), the processing proceeds to S310. If the determination result indicating that the detected card position is not the correct position is obtained (NO in S309), the processing proceeds to S350. Note that, it is desirable for the determination on the card position in S308 and S309 to have a range to some extent in the vertical direction and the horizontal direction for the correct position. This is because, if the card position is determined strictly, it is determined that the position of the card is not the correct position even in a case where the position of the card placed on the platen glass is displaced from the correct position only slightly or is skewed relative to the correct position, and the usability is degraded. Setting of the check range of the card position is described later in a flowchart in FIG. 5.

In S350, the ID card copying processing unit 214 displays a card position warning screen indicating that the position of the ID card placed on the platen glass is not the correct position on the operation unit 107 via the screen control unit 211. Note that, once the processing in S350 ends, the processing returns to S302.

### (Card Position Warning Screen)

FIG. 4D is a diagram illustrating a card position warning screen example. A card position warning screen 440 includes a message 441, a guide display region 442, and the “continue” button 443. The card position warning screen 440 is also used in S370 (a warning for the second scanning) described later.

The message 441 is a message indicating that the position of the card placed on the platen glass is wrong and an operation procedure to continue the processing. The guide display region 442 is a region to display the guide image describing the position in which the ID card should be placed on the platen glass. As with the other guide display region, the guide display region 442 is a region to display the image expressing the ID card in the appropriate position depending on the setting. Additionally, the design of the card displayed in the guide display region 442 is also switched depending on the situation. The guide display region 442 in FIG. 4D illustrates an example of a case where the layout method of other than Full (the correct card position is the upper left) is set, and it is a warning corresponding to the second scanning (the design of the card is the front surface). The “continue” button 443 is a button to instruct the processing to continue.

Additionally, the card position warning screen may display both the current position of the card placed on the platen glass and the correct position of the card placed on the platen glass.

### (Card Position Warning Screen)

FIG. 4E is a diagram illustrating a card position warning screen example that displays both the current placed position of the card and the correct placed position of the card. A card position warning screen 450 includes a message 451, a current position guide display region 452, a correct position guide display region 453, and the “continue” button 454. The message 451 is a message indicating that the position of the card placed on the platen glass is wrong and an operation procedure to continue the processing. The current position guide display region 452 is a region to display an image indicating the current position of the ID card placed on the platen glass. The correct position guide display region 453 is a region to display a guide image describing the position in which the ID card should be placed on the platen glass. It is possible to display more clearly how to place the card again by presenting both the current position and correct position of the ID card. The “continue” button 454 is a button to instruct the processing to continue.

Back to the description of the flowchart in FIG. 3A. In S310, the ID card copying processing unit 214 executes the first scanning by controlling the scanner 111 via the scanner control unit 212 and generates the image data. That is, the ID card copying processing unit 214 obtains a single scanned image corresponding to the front surface of the ID card (a single original surface) obtained by scanning the front surface of the ID card. In S311, the ID card copying processing unit 214 displays a turn-over instruction screen indicating an instruction to turn over the ID card placed on the platen glass on the operation unit 107 via the screen control unit 211.

### (Card Turn-Over Instruction Screen)

FIG. 4F is a diagram illustrating a card turn-over instruction screen example. A card turn-over instruction screen 460 includes a message 461, a guide display region 462, a “stop” button 463, and a “continue” button 464. The message 461 is a message indicating that the ID card placed on the platen glass needs to be turned over and an operation procedure to continue the processing. The guide display region 462 is a region to display a guide image describing the position in which the ID card should be placed on the platen glass. As with the other guide display region, the guide display region 462 is a region to display the image expressing the ID card in the appropriate position depending on the layout setting. Additionally, the design of the card displayed in the guide display region 462 is also switched depending on the situation. The guide display region 462 in FIG. 4F illustrates an example of a case where the layout method of other than Full (the correct card position is the upper left) is set. The “stop” button 463 is a button to instruct the processing to stop. The “continue” button 464 is a button to instruct the processing to continue.

Note that, after the processing in S311, the ID card placed on the platen glass is turned over by the user operation, and the ID card is placed in a predetermined position on the platen glass with the front surface of the ID card facing up.

In S312, the ID card copying processing unit 214 waits for an operation by the user via the screen control unit 211. That is, the ID card copying processing unit 214 waits for an input by the user operation on the card turn-over instruction screen 460. In S313, the ID card copying processing unit 214 determines the type of the button pressed by the user. The processing diverges depending on the determination result. That is, if the detected button pressed by the user is the “stop” button, the flowcharts illustrated in FIG. 3A and FIG. 3B ends, and if the detected button pressed by the user is the “continue” button, the processing proceeds to S314.

In S314, as with S304, the ID card copying processing unit 214 executes the pre-scanning by controlling the scanner 111 via the scanner control unit 212. In S315, as with S305, the ID card copying processing unit 214 detects the card position from the image data obtained by the pre-scanning in S314. That is, the ID card copying processing unit 214 identifies the position of the ID card placed on the platen glass.

In S316, the ID card copying processing unit 214 determines whether the card position can be detected in S315. The processing diverges depending on the determination result. If the determination result indicating that the card position can be detected is obtained (YES in S316), the processing proceeds to S317. If the determination result indicating that the card position cannot be detected is obtained (NO in S316), the processing proceeds to S360. In S360, as with S340, the ID card copying processing unit 214 displays the no card warning screen indicating that no ID card is placed on the platen glass on the operation unit 107 via the screen control unit 211. Note that, once the processing in S360 ends, the processing returns to S312.

In S317, the ID card copying processing unit 214 determines whether the layout method of Full is set as the layout setting. If the determination result indicating that the layout method of Full is set is obtained (YES in S317), the processing proceeds to S318. If the determination result indicating that the layout method of Full is not set is obtained (NO in S317), the processing proceeds to S319. In S318, the ID card copying processing unit 214 determines whether the detected card position is placed in the correct position. That is, whether the detected card position is placed in the left center, which is the position in the center in the left half region of the platen glass, is determined. Note that, the check range used in S319 is also set with reference to FIG. 5 described later, for example.

If the determination result indicating that the detected card position is the correct position (the left center) is obtained (YES in S318), the processing proceeds to S320. If the determination result indicating that the detected card position is not the correct position (the left center) is obtained (NO in S318), the processing proceeds to S370. On the other hand, in S319, the ID card copying processing unit 214 determines whether the detected card position is placed in the correct position. That is, whether the detected card position is placed at the upper left, which is the position at the upper left on the platen glass, is determined. Note that, the check range used in S319 is also set with reference to FIG. 5 described later, for example. If the determination result indicating that the detected card position is the correct position (the upper left) is obtained (YES in S319), the processing proceeds to S320. If the determination result indicating that the detected card position is not the correct position (the upper left) is obtained (NO in S319), the processing proceeds to S370. Note that, as with S308 and S309, it is desirable for the determination on the card position in S318 and S319 to have a range to some extent in the vertical direction and the horizontal direction for the correct position.

In S370, as with S350, the ID card copying processing unit 214 displays the card position warning screen indicating that the position of the ID card placed on the platen glass is not the correct position on the operation unit 107 via the screen control unit 211. Note that, once the processing in S370 ends, the processing returns to S312.

In S320, the ID card copying processing unit 214 executes the second scanning by controlling the scanner 111 via the scanner control unit 212 and generates the image data. That is, the ID card copying processing unit 214 obtains a single scanned image corresponding to the back surface of the ID card (a single original surface) obtained by scanning the back surface of the ID card.

In S321, the ID card copying processing unit 214 generates the printing data based on the image data generated in the first scanning (S310) and the image data generated in the second scanning (S320). In this process, the positions where the two image data are to be laid out on the sheet are determined according to the set layout method. That is, the ID card copying processing unit 214 generates the combined image, which is obtained by integrating the two scanned images corresponding to the two original surfaces obtained by scanning the front surface and the back surface of the specific original, according to the set layout method. In S322, the ID card copying processing unit 214 controls the printer 112 via the printer control unit 213 and prints the image based on the printing data generated in S321 on the sheet.

The flowcharts illustrated in FIG. 3A and FIG. 3B ends with the above-described processing. In the present embodiment, a case where the combined image, which is obtained by integrating the two image data corresponding to the front surface and the back surface of the single ID card, is printed on one surface of the single sheet is described; however, it is not limited thereto. For example, the present embodiment may be applied to a case where the combined image, which is obtained by integrating two image data in total that are corresponding to one surface of each of two ID cards, is printed on one surface of the single sheet.

### (Processing of Setting Check Range)

FIG. 5 is a flowchart illustrating a flow of processing of setting the check range used in the ID card copying function. The flowchart in FIG. 5 is implemented with the CPU 102 of the image formation apparatus reading out the program to implement each block in FIG. 2 stored in the ROM 104 or the HDD 105 to the RAM 103 to execute.

In S308, S309, S318, and S319 in the flowcharts in FIG. 3A and FIG. 3B, whether the card position (the position of the specific original) is in the correct position is determined. In this determination, the check range having a range to some extent in the vertical direction and the horizontal direction for the correct position determined in advance is used. In the flowchart in FIG. 5, the size of the check range used for the determination of the card position is set. Note that, although a case where the setting of the check range of the card position is not on the ID card copying screen 410 but exists as an independent setting screen is described in the present embodiment, it is not limited thereto. For example, the size of the check range of the card position may be set on the ID card copying screen 410.

In S501, the ID card copying processing unit 214 displays a card position check range setting screen on the operation unit 107 via the screen control unit 211.

### (Card Position Check Range Setting Screen)

FIG. 4G is a diagram illustrating a card position check range setting screen example. A card position check range setting screen 470 includes a slider 471, a range preview 472, and an “OK” button 473. The slider 471 is a part to set a width of the range (the check range) in which it is determined that the card position is in the correct position, and it is possible to increase and decrease the range by sliding in the horizontal direction. The range preview 472 is an area to indicate the check range of the card position, and a rectangular of a dotted line indicating the check range is updated in cooperation with the operation of the slider 471. In the check range, for example, standard is a range of the size that is enlarged approximately 1.3 times greater in the horizontal direction and the vertical direction than a range of the size of the specific original in the correct position.

Narrow is a range of the size that is enlarged approximately 1.1 times greater in the horizontal direction and the vertical direction than a range of the size of the specific original in the correct position. Additionally, wide is a range of the size that is enlarged approximately 1.5 times greater in the horizontal direction and the vertical direction than a range of the size of the specific original in the correct position. Note that, the correct position is the placed position of the specific original on the platen glass, which is determined in advance in correspondence with the layout method.

The “OK” button 473 is a button to determine the setting and return to a previous screen. Note that, although the check range has a common width (the size) in all the regions in the present embodiment, the width may be set for each region. That is, all the margin regions in the right direction, the left direction, the up direction, and the bottom direction may have the same width with respect to the correct position, or the four margin regions may have different widths, respectively.

Back to the description of the flowchart (FIG. 5). In S502, the ID card copying processing unit 214 reads a value of the current check range from the HDD 105.

In S503, the ID card copying processing unit 214 updates the range preview 472 according to the value of the current check range. For example, in a case where the value of the current check range obtained by reading the range preview 472 in S502 is “standard”, the ID card copying processing unit 214 updates the range preview 472 according to a value corresponding to “standard” of the current check range.

In S504, the ID card copying processing unit 214 waits for the user operation via the screen control unit 211. In S505, the ID card copying processing unit 214 determines the detected user operation. The processing diverges depending on the determination result. That is, if the detected user operation is the operation of the slider 471, the processing proceeds to S510, and if the detected user operation is pressing of the “OK” button 473, the processing proceeds to S506. In S510, the ID card copying processing unit 214 updates the value of the current check range according to the value of the slider that is designated by the user. For example, in a case where the user designates “wide” of the check range by operating the slider, the value of the current check range is updated to a value corresponding to “wide” of the check range. Note that, once the processing in S510 ends, the processing returns to S503.

In S506, the ID card copying processing unit 214 stores the value of the current check range in the HDD 105. Once the processing in S506 ends, the flow illustrated in FIG. 5 ends.

As described above, according to the present embodiment, it is possible to confirm and set the check range to check whether the position of the specific original placed on the platen glass is the correct position before executing the ID card copying function. Therefore, it is possible to reduce copying (miscopying) in a case where the position of the specific original placed on the platen glass is not the correct position, and consequently, it is possible to improve the usability.

### Embodiment 2

In the present embodiment, an aspect in which, instead of executing both the pre-scanning and normal scanning of the one surface of the specific original, the normal scanning is executed once is described. The present embodiment is a modification of the embodiment 1; for this reason, a difference from the embodiment 1 is mainly described.

### (Processing of Executing ID Card Copying Function)

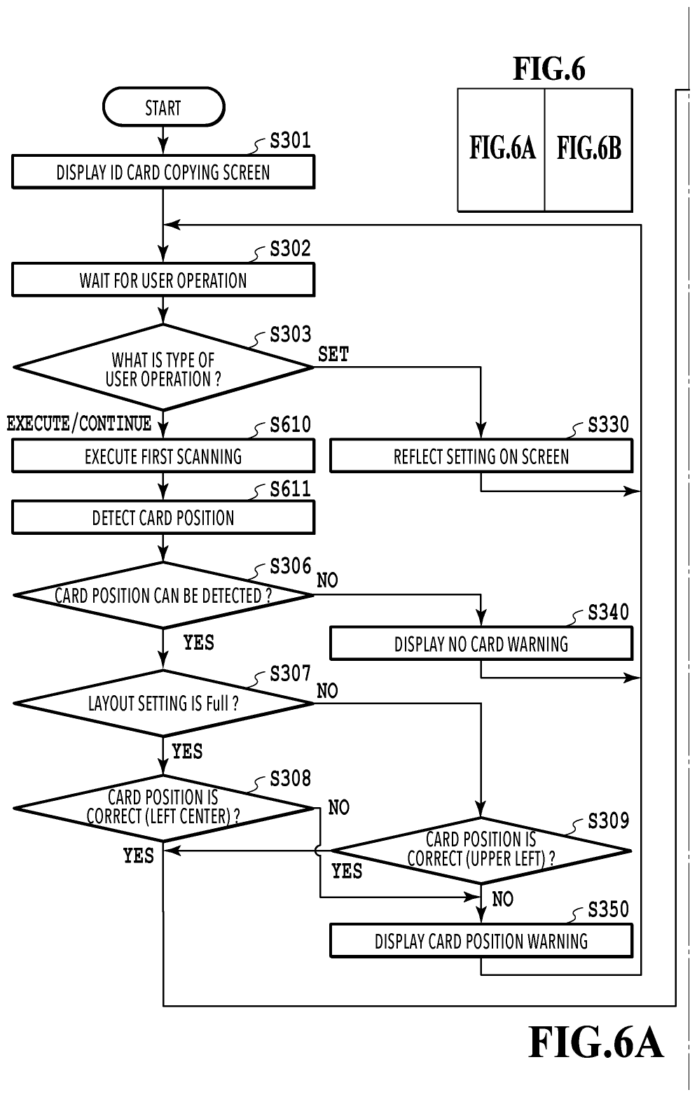

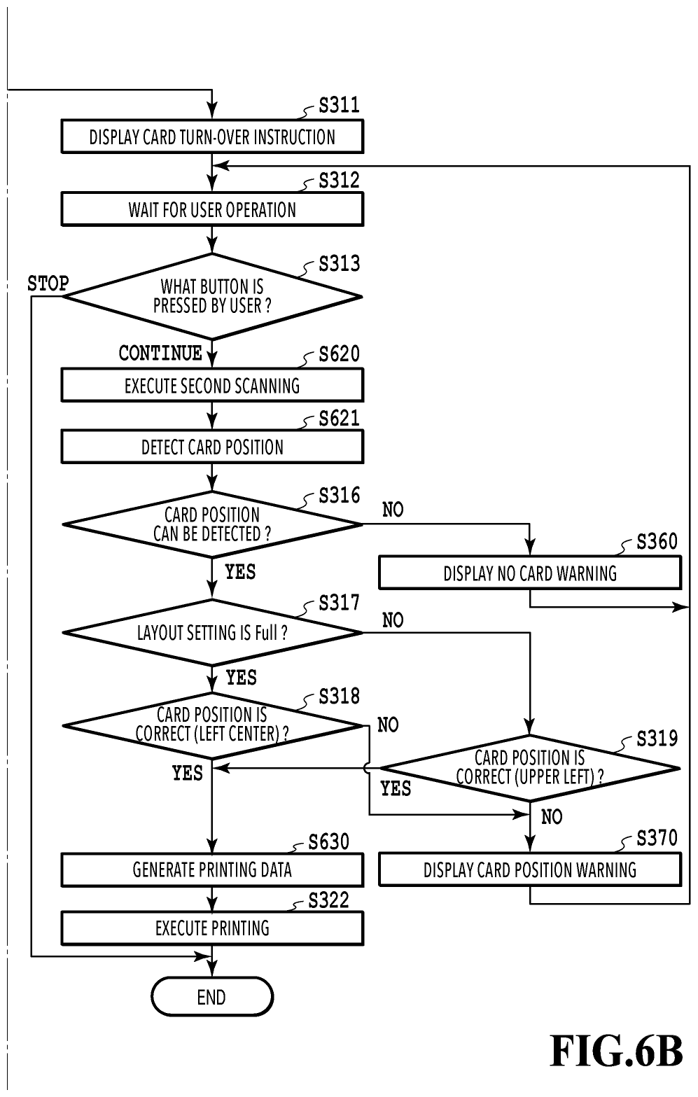

FIG. 6A and FIG. 6B are flowcharts describing processing of the ID card copying function executed by the image formation apparatus 100 according to the present embodiment. FIG. 6A and FIG. 6B are flowcharts that are a modification of the flowcharts illustrated in FIG. 3A and FIG. 3B. A difference from FIG. 3A and FIG. 3B is mainly described.

The flowchart in FIG. 6A and FIG. 6B are implemented with the CPU 102 of the image formation apparatus reading out the program to implement each software module stored in the ROM 104 or the HDD 105 to the RAM 103 to execute. If the type of the user operation detected in S303 is “execute” or “continue”, the processing proceeds to S610.

In S610, as with S310, the ID card copying processing unit 214 executes scanning by controlling the scanner 111 via the scanner control unit 212 and generates the image data. That is, the ID card copying processing unit 214 obtains a single scanned image corresponding to the front surface of the ID card (a single original surface) obtained by scanning the front surface of the ID card.

In S611, the ID card copying processing unit 214 detects the card position from the image data obtained by the scanning in S610. Specifically, the ID card copying processing unit 214 identifies the position of the ID card placed on the platen glass by performing image recognition on the image data generated by scanning the entire platen glass and identifying the position of the ID card in the image data. Note that, once the processing in S611 ends, the processing proceeds to S306.

If the determination result indicating that the button pressed by the user in S313 is “continue” is obtained (YES in S313), the processing proceeds to S620. In S620, as with S610, the ID card copying processing unit 214 executes scanning by controlling the scanner 111 via the scanner control unit 212 and generates the image data. That is, the ID card copying processing unit 214 obtains a single scanned image corresponding to the front surface of the ID card (the single original surface) obtained by scanning the front surface of the ID card.

In S621, as with S611, the ID card copying processing unit 214 detects the card position from the image data obtained by the scanning in S620. Note that, once the processing in S621 ends, the processing proceeds to S316.

If the determination result indicating that the card position detected in S318 is the correct position (the left center) is obtained (YES in S318), the processing proceeds to S630. Alternatively, if the determination result indicating that the card position detected in S319 is the correct position (the upper left) is obtained (YES in S319), the processing proceeds to S630.

In S630, the ID card copying processing unit 214 generates the printing data based on the image data generated in the first scanning (S610) and the image data generated in the second scanning (S620). In this process, the positions where the two image data are to be laid out on the sheet are determined according to the set layout method. That is, the ID card copying processing unit 214 generates the combined image, which is obtained by integrating the two scanned images corresponding to the two original surfaces obtained by scanning the front surface and the back surface of the specific original, according to the set layout method. Note that, in S322, the ID card copying processing unit 214 controls the printer 112 via the printer control unit 213 and prints the image based on the printing data generated in S630 on the sheet.

As described above, according to the present embodiment, it is possible to check whether the position of the ID card placed on the platen glass is the correct position by executing the scanning once for each one of the surfaces of the specific original.

### Embodiment 3

In the present embodiment, an aspect in which an original size detection function of the scanner 111 is used without performing the pre-scanning and the scanning for the position detection of the specific original, is described. The present embodiment is a modification of the embodiment 1; for this reason, a difference from the embodiment 1 is mainly described.

### (Processing of Executing ID Card Copying Function)

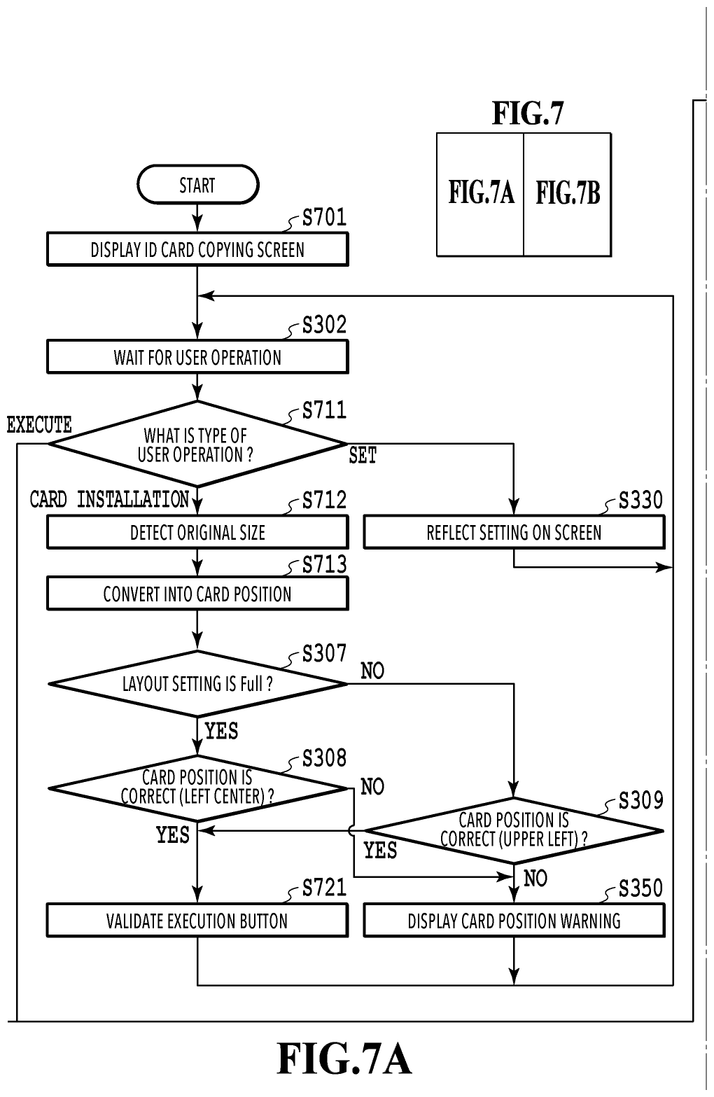

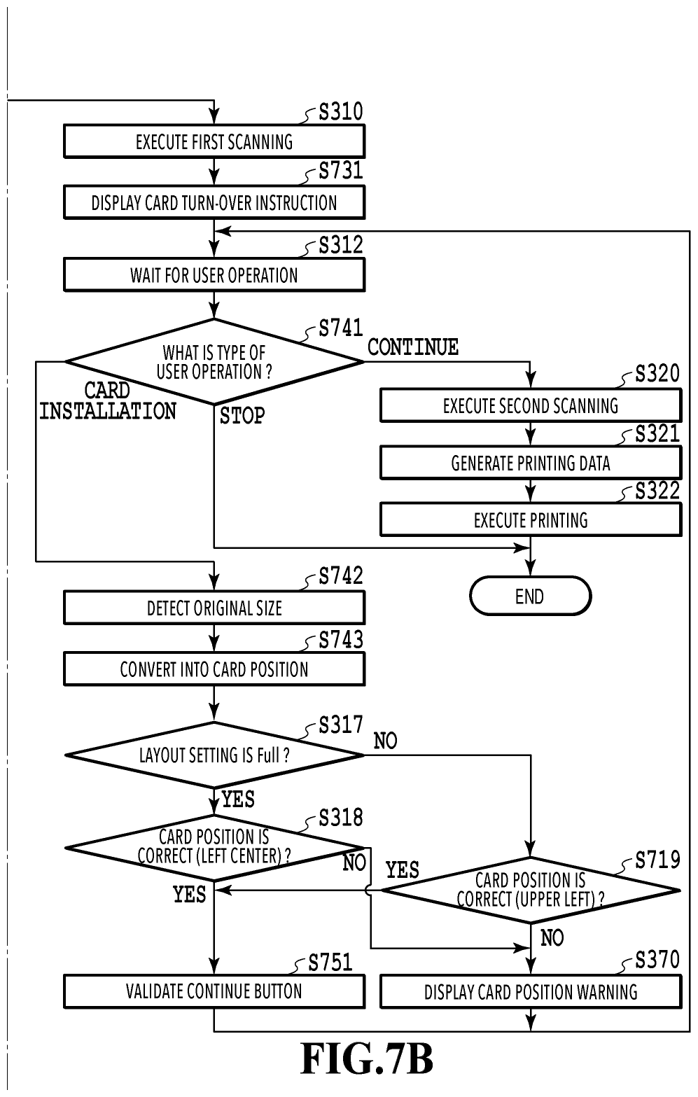

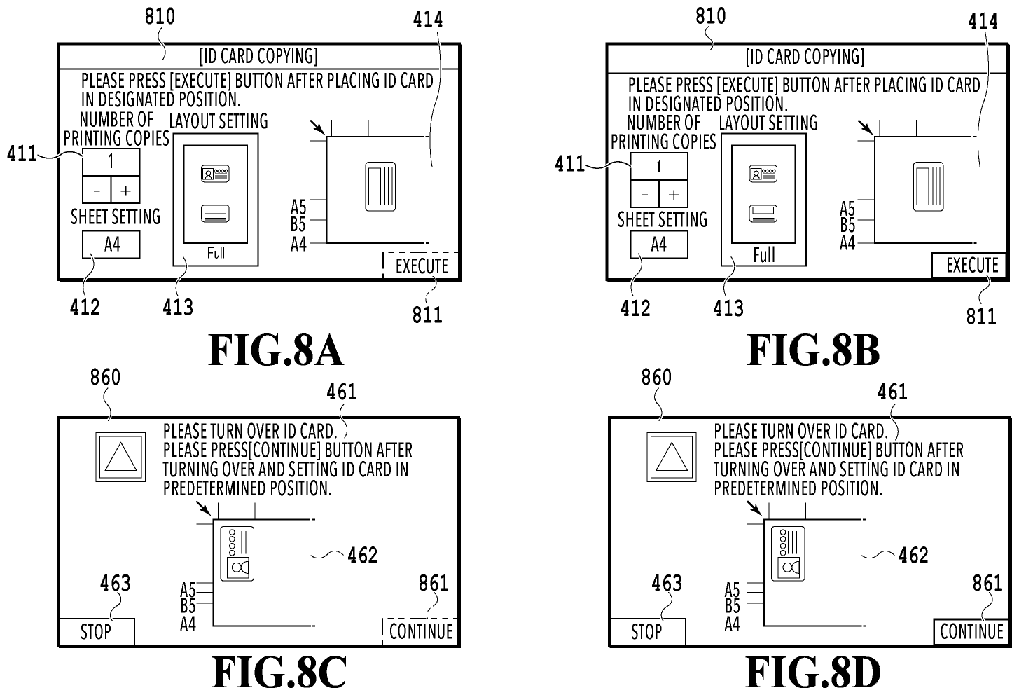

FIG. 7A and FIG. 7B are flowcharts describing processing of the ID card copying function executed by the image formation apparatus 100 according to the present embodiment. FIG. 7A and FIG. 7B are flowcharts that are a modification of the flowcharts illustrated in FIG. 3A and FIG. 3B. A difference from FIG. 3A and FIG. 3B is mainly described.

The flowchart in FIG. 7A and FIG. 7B is implemented with the CPU 102 of the image formation apparatus reading out the program to implement each software module stored in the ROM 104 or the HDD 105 to the RAM 103 to execute.

In S701, in a case where the screen control unit 211 receives the instruction to execute the ID card copying function by the user operation on the operation unit 107, the screen control unit 211 activates the ID card copying application and displays the ID card copying screen on the operation unit 107.

### (ID Card Copying Screen)

FIGS. 8A and 8B are diagrams illustrating an ID card copying screen example according to the present embodiment. FIG. 8A illustrates a state before it is determined that the position of the specific original placed on the platen glass is the correct position, and FIG. 8B illustrates a state after it is determined that the position of the specific original placed on the platen glass is the correct position.

As with the ID card copying screen 410, an ID card copying screen 810 includes the copy number setting 411, the sheet size setting 412, the layout setting 413, and the guide display region 414. Additionally, the ID card copying screen 810 includes an “execute” button 811 corresponding to the “execute” button 415 on the ID card copying screen 410.

Note that, for example, before it is determined that the position of the specific original placed on the platen glass is the correct position like in S701, the “execute” button 811 is displayed in an invalid state in which the user operation cannot be performed and no pressing is allowed as illustrated in FIG. 8A. On the other hand, for example, after it is determined that the position of the specific original placed on the platen glass is the correct position like in S721 described later, the “execute” button 811 is displayed in a valid state in which the user operation can be performed and pressing is allowed as illustrated in FIG. 8B.

Once the processing in S302 ends, the processing proceeds to S711. Note that, in a case where the processing returns from S721 to S302, the ID card copying screen 810 including the “execute” button 811 in the valid state in which the user operation can be performed and the pressing is allowed is displayed.

In S711, the ID card copying processing unit 214 determines the type of the detected user operation. The processing diverges depending on the determination result. That is, if the type of the detected user operation is pressing of a “set” button, the processing proceeds to S330, if the type of the detected user operation is pressing of the “execute” button, the processing proceeds to S310, and if the type of the detected user operation is “card installation”, the processing proceeds to S712. “Card installation” means an operation to place the ID card on the platen glass and close the cover of the platen glass.

In S712, the ID card copying processing unit 214 detects the sheet size (hereinafter, the original size) of the original placed on the platen glass by controlling the scanner 111 via the scanner control unit 212. A detection method and a detection capability of the original size are different depending on the scanner 111; however, in the present embodiment, it is possible to detect each size of card size, A5, B5, and A4 depending on a position of a detected edge at the lower right of the original.

In S713, the ID card copying processing unit 214 converts the original size detected in S712 into the card position. For example, the size of the specific original and the card position are associated with each other like “upper left for card size” and “left center for B5”, and the detected original size is converted into the card position according to this association.

If the determination result indicating that the card position is the correct position is obtained in S308 (YES in S308), or if the determination result indicating that the card position is the correct position is obtained in S309 (YES in S309), the processing proceeds to S721. In S721, the ID card copying processing unit 214 validates the “execute” button on the ID card copying screen and updates the state to the state in which pressing is allowed. That is, as illustrated in FIG. 8B, the ID card copying processing unit 214 displays the “execute” button 811 in the valid state in which the user operation can be performed and pressing is allowed.

Once the processing in S310 ends, the processing proceeds to S731. In S731, the ID card copying processing unit 214 displays the card turn-over instruction screen 460 on the operation unit 107 via the screen control unit 211. Note that, in S731, a “continue” button 861 is displayed on the card turn-over instruction screen in the invalid state in which the user operation cannot be performed and no pressing is allowed.

### (Card Turn-Over Instruction Screen)

FIGS. 8C and 8D are diagrams illustrating a card turn-over instruction screen example of the present embodiment. FIG. 8C illustrates a state before it is determined that the position of the specific original placed on the platen glass is the correct position, and FIG. 8D illustrates a state after it is determined that the position of the specific original placed on the platen glass is the correct position.

As with the card turn-over instruction screen 460, a card turn-over instruction screen 860 includes the message 461, the guide display region 462, and the “stop” button 463. Additionally, the card turn-over instruction screen 860 includes the “continue” button 861 corresponding to the “continue” button 464 of the card turn-over instruction screen 460.

Note that, for example, before it is determined that the position of the specific original placed on the platen glass is the correct position like in S731, the “continue” button 861 is displayed in the invalid state in which the user operation cannot be performed and no pressing is allowed as illustrated in FIG. 8C. On the other hand, for example, after it is determined that the position of the specific original placed on the platen glass is the correct position like in S751 described later, the “continue” button 861 is displayed in the valid state in which the user operation can be performed and pressing is allowed as illustrated in FIG. 8D.

Once the processing in S312 ends, the processing proceeds to S741. Note that, in a case where the processing returns from S751 to S312, the card turn-over instruction screen 860 including the “continue” button 861 in the valid state in which the user operation can be performed and pressing is allowed is displayed.

In S741, the ID card copying processing unit 214 determines the type of the detected user operation. The processing diverges depending on the determination result. That is, if the type of the detected user operation is pressing of the “stop” button 463, the processing illustrated in FIG. 7A and FIG. 7B ends. If the detected user operation is pressing of the “continue” button 861, the processing proceeds to S320, and if the detected user operation is “card installation”, the processing proceeds to S742.

In S742, as with S712, the ID card copying processing unit 214 detects the original size by controlling the scanner 111 via the scanner control unit 212. In S743, as with S713, the ID card copying processing unit 214 converts the original size detected in S742 into the card position.

If the determination result indicating that the card position is the correct position is obtained in S318 (YES in S318), or if the determination result indicating that the card position is the correct position is obtained in S319 (YES in S319), the processing proceeds to S751. In S751, the ID card copying processing unit 214 validates the “continue” button on the card turn-over instruction screen and updates the state to the state in which pressing is allowed. That is, as illustrated in FIG. 8D, the ID card copying processing unit 214 displays the “continue” button 861 in the valid state in which the user operation can be performed and pressing is allowed.

As described above, according to the present embodiment, it is possible to check whether the position of the specific original placed on the platen glass is the correct position by the detection result obtained by using the original size detection function that the image formation apparatus has.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, it is possible to improve the usability in a case where a combined image, which is obtained by integrating two scanned images of a specific original, is generated.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-193560, filed Nov. 14, 2023, which is hereby incorporated by reference wherein in its entirety.

What is claimed is:

1. An image formation apparatus, comprising:
a setting unit configured to set a layout method applied in a case where a combined image, which is obtained by integrating two scanned images corresponding to two original surfaces obtained by scanning a specific original, is generated;
a detection unit configured to detect a position of the specific original placed on a platen glass for the scanning; and
a notification unit configured to notify of a warning message in a case where the position of the specific original detected by the detection unit is different from a position of the specific original according to the layout method set by the setting unit.

2. The image formation apparatus according to claim 1, wherein
the detection unit detects the position of the specific original based on image data obtained by pre-scanning the specific original placed on the platen glass.

3. The image formation apparatus according to claim 1, wherein
the detection unit detects the position of the specific original based on image data obtained by scanning the specific original placed on the platen glass.

4. The image formation apparatus according to claim 1, further comprising:
an original size detection unit configured to detect an original size of an original placed on the platen glass, wherein
the detection unit detects the position of the specific original based on a detection result detected by the original size detection unit.

5. The image formation apparatus according to claim 1, wherein
the detection unit detects the position of the specific original by checking a range determined in advance on the platen glass.

6. The image formation apparatus according to claim 1, wherein
the notification unit notifies of the warning message and an operation procedure to continue the processing.

7. The image formation apparatus according to claim 1, wherein
the notification unit presents a correct position of the specific original placed on the platen glass for scanning to a user.

8. The image formation apparatus according to claim 1, wherein
the notification unit presents both a current position of the specific original placed on the platen glass and a correct position of the specific original placed on the platen glass for the scanning to a user.

9. The image formation apparatus according to claim 1, wherein
the notification unit notifies of a warning for first scanning of the specific original and a warning for second scanning of the specific original using different designs.

10. The image formation apparatus according to claim 1, further comprising:
a display control unit while there are a plurality of the layout methods, the display control unit being configured to display a UI screen to set one layout method out of the plurality of the layout methods, wherein
the setting unit sets the one layout method based on a user operation via the UI screen displayed by the display control unit.

11. The image formation apparatus according to claim 10, wherein
the plurality of the layout methods are each associated with the position of the specific original placed on the platen glass for the scanning.

12. The image formation apparatus according to claim 1, wherein
the layout method is applied in a case where a combined image, which is obtained by integrating two scanned images corresponding to two original surfaces obtained by scanning a front surface and a back surface of the specific original, is generated.

13. The image formation apparatus according to claim 1, wherein
the layout method is applied in a case where a combined image, which is obtained by integrating two scanned images corresponding to two original surfaces obtained by scanning a front surface of each of two specific originals, is generated.

14. The image formation apparatus according to claim 1, wherein
the specific original is an ID card.

15. An image formation method, comprising:
setting a layout method applied in a case where a combined image, which is obtained by integrating two scanned images corresponding to two original surfaces obtained by scanning a specific original, is generated;
detecting a position of the specific original placed on a platen glass for the scanning; and
notifying of a warning message in a case where the position of the specific original detected by the detecting is different from a position of the specific original according to the layout method set by the setting.

16. A non-transitory computer readable storage medium storing a program which causes a computer to perform an image formation method, comprising:
setting a layout method applied in a case where a combined image, which is obtained by integrating two scanned images corresponding to two original surfaces obtained by scanning a specific original, is generated;
detecting a position of the specific original placed on a platen glass for the scanning; and
notifying of a warning message in a case where the position of the specific original detected by the detecting is different from a position of the specific original according to the layout method set by the setting.
